(19) United States
(12) Patent Application Publication
(10) Pub. No.: US 2005/0039038 A1
(43) Pub. Date: Feb. 17, 2005

(54) Method to secure service provider sensitive data

(76) Inventors: Nagaraja Rao, Boca Raton, FL (US); Jim Stanco, Wellington, FL (US)

Correspondence Address: Elsa Keller;Siemens Corporation, Intellectual Property Department, 170 Wood Avenue South, Iselin, NJ, 08830, US

(21) Appl. No.: 10/809,628

(22) Filed: Mar. 25, 2004

Related U.S. Application Data
(60) Provisional application No. 60/457,349, filed on Mar. 25, 2003.

(51) Int. Cl. H04L 9/32

(52) U.S. Cl. 713/194

(57) ABSTRACT

Securing intercept related data (or other sensitive service provider data) used by a switch of a telecommunications service provider and stored in a database associated with the switch is provided. That portion of the database including the intercepted telecommunications data is encrypted. Another entity outside the telecommunications service provider is prevented from decrypting that portion of the database including the intercepted telecommunications data without authorization from the telecommunications service provider.

### PRIORITY OF INVENTION

The instant application claims priority to the U.S. Provisional Application Ser. No. 60/457,349, filed Mar. 25, 2003, entitled ‘A Method to Secure Service Provider's Sensitive Data from Vendors’ the contents of which is incorporated in its entirety herein.

### FIELD OF THE INVENTION

The present invention relates to securing sensitive data and, more particularly to securing sensitive service provider data from personnel of a vendor during support of product support activities. The invention is useful in surveillance applications, such as those created in accordance with the Communications Assistance for Law Enforcement Act (CALEA). In such applications, surveillance data is accumulated by a service provider and must be protected against unauthorized access. Potential for unauthorized access could occur, for example, during a product support activity, which sometimes requires the entire switch data base to be sent to a vendor.

### BACKGROUND

Lawful surveillance of telecommunications traffic is an important and rapidly growing field. Although, surveillance has long been in existence, new technologies have emerged in recent years which have stymied lawful surveillance.

For this reason, governments around the world have enacted legislation for the lawful gathering and surveillance of modern day telecommunications. The Communications Assistance for Law Enforcement Act (CALEA), for example, was passed in the United States in 1994 in response to these rapid advances in telecommunications technology. CALEA requires telecommunications Carriers to ensure that their equipment, facilities, and services are able to comply with authorized electronic surveillance. The Federal Communications Commission (FCC) has been tasked with enforcing the CALEA provisions to ensure that technology does not avert the will of law. Other countries and jurisdictions have enacted similar laws.

The regulations also have as a requirement the necessity to secure the surveillance data from all those who are not authorized. These stem from the individuals right of privacy and the telecommunication industry's desire to satisfy customers as well as avoid law suits for negligent care of personal data. In the case of surveillance information, the need for security is driven by Law Enforcement's need to keep the surveillance subject unaware that they are under surveillance.

Problematically, the data often falls into the possession of third parties, such as vendors. In one scenario, the surveillance data is stored within a switching center, such as an EWSD (Electronisch Wahl System Digital), in a secured database in an encrypted form. The surveillance data may include such sensitive information as the caller's identification, the type of message intercepted, and where the intercepted information is delivered.

In the case that a switch is sent to a vendor, such as for an upgrade, the database is necessarily sent. The database, which includes the surveillance information, needs to be accessed by the vendor personnel without giving them access to the sensitive surveillance data.

To date, there is no method to preventing such unauthorized personnel from decoding the surveillance data by loading a copy of the database onto a system where the personnel has control (i.e., where the personnel has “super-user access”).

### OBJECTS & SUMMARY OF THE INVENTION

An object of the present invention is to provide secure service provider sensitive data.

An object of the invention is to provide secure service provider sensitive data in surveillance applications.

An object of the invention is to provide secure service provider sensitive data in surveillance applications, such as those created in accordance with the Communications Assistance for Law Enforcement Act (CALEA).

An object of the invention is to secure surveillance data accumulated by a service provider and potentially accessible to unauthorized personnel.

An object of the invention is to provide secure surveillance data during a product support activity.

In accordance with the objects of the present invention, there is provided a system, method and apparatus for

securing intercepted telecommunications data collected by a switch of a telecommunications service provider and stored in a database associated with the switch is provided. That portion of the database including the intercepted telecommunications data is encrypted. Another entity outside the telecommunications service provider is prevented from decrypting that portion of the database including the intercepted telecommunications data without authorization from the telecommunications service provider.

Further, the invention provides software methods for a locked box allowing the service provider to place the sensitive data and messages in the locked box with a secured key. Unless the locked box is opened, no one is granted access, including the authorized personnel of the service provider.

In another embodiment, the software automatically locks the box any time an attempt is made to reset the switch. This ensures that, after a system recovery or a software upgrade process, the box is still locked.

In addition, there are provided special upgrade procedures

Thus, the present invention provides a method and apparatus to secure sensitive data and, more particularly to securing sensitive service provider data from personnel of a vendor during support of product support activities. It also provides a method of securing sensitive data from unauthorized service personnel attempts to bypass the system security by loading a copy of the database on a different switch that they have control over (for example, a lab switch). The invention provides secure data in surveillance applications, such as those created in accordance with the Communications Assistance for Law Enforcement Act (CALEA) and prevents surveillance data accumulated by a service provider to be accessed by unauthorized personnel. The invention provides that the surveillance data is secure, for example, during a product support activity, which sometimes requires the entire switch data base to be sent to a vendor.

### BRIEF DESCRIPTION OF THE DRAWINGS

The following figures illustrate the present invention in particular detail, and it shall be considered that the figures are merely examples:

FIG. 1 is a block diagram according to one particularly preferred embodiment of the present invention;

FIG. 2A-2C is a process flow diagram according to one particularly preferred embodiment of the present invention; and

FIGS. 3A-3C is another process flow diagram according to one particularly preferred embodiment of the present invention.

### DETAILED DESCRIPTION OF THE PREFERRED EMBODIMENTS

As already discussed, there is a need to protect surveillance data provisioned by the authorized personnel of the telecommunications operating company (Telco). Indeed, this data should have the highest provisioned level of security possible within the switch. Special care must be taken to prevent an unauthorized person from collecting the information about the surveillance intercept directory numbers (DNs). In order to provide such a security measure, this invention sets forth, as will be later described, certain blocking procedures for the specific commands that display the related data such that they may be executed only by the authorized personnel of the Telco. In particular, specific commands are associated with a special authorization class, which permits the authorized personnel of the telephone company that possess that level of authorization to access the surveillance data. In this manner, the invention prevents unauthorized access or manipulation of the surveillance data within the Telco.

Outside the Telco, however, it is the current situation that the vendor personnel have access to the secure data since the vendor is presumed to have the highest level of authorization (authorization class 1) for which all the general switch commands are known and available. In the EWSD example, there are man machine language (MML) commands that is defined by the switch that the vendor is aware of. Since the vendor personnel with an authorization class 1 can execute such MML commands, the vendor can in fact easily access the secure data base.

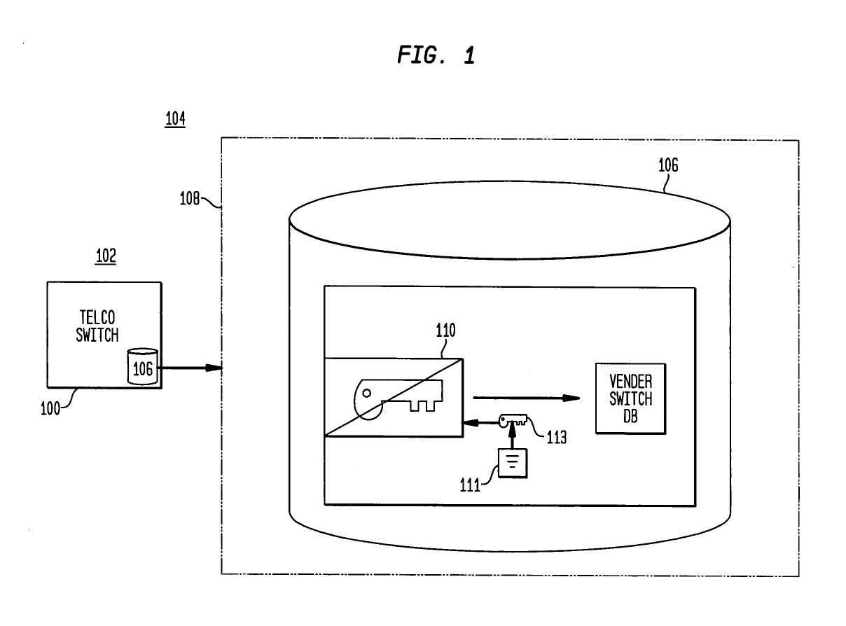

Referring to FIG. 1, in normal practice, an database upgrade for the switch of the telephone switching system 100 itself (e.g., and EWSD) does not require that the switch itself be removed from the Telco 102 facilities and sent to the vendor 104. Instead, a file containing the switch database 106 is typically sent to the vendor 104 when the vendor 104 is asked to troubleshoot a problem or to allow the vendor 104 to prepare the database 106 for a switch software upgrade. Such upgrades occur, for example, when the Telco upgrades the switch software from one release to the next.

This database 106 contains sensitive information 110 that would normally be viewable by the vendor 104 once the database 106 is installed on a similar switch 108 in the vendor lab. The apparatus of this invention provides the vendor 104 the ability to perform the normal upgrade or debugging tasks while protecting the sensitive data 110 from unauthorized access. In one particularly preferred embodiment, this is accomplished through encryption of the sensitive data 110. In another particularly preferred embodiment, the display of the sensitive data is disabled. Both of these functions may be allowed again once the database is returned to the Telco with the software key provided within database 106.

In one embodiment, the present invention blocks certain MML commands when the security lock is applied, thereby preventing the viewing of the database. As depicted in FIG. 1, the programming needed to generate the key 111, and the key 113 itself, are stored within the database 110. The present invention proposes, for purposes of absolute security, that the key 113 be in the form of a “safe deposit box key.” In other words, there is only one copy of the key, and it is not duplicated anywhere. That is to say, if the key is lost, then there is no way to open the database. Since there is no copies of the key stored anywhere on the switch, there is no chance that the key 113 can be hacked and applied to open the box. The key could be an 8 letter alphanumeric character string stored within the switch in encrypted form, a pass phrase, PGP key, certificate, or other software security equivalent.

It shall also be appreciated that the database 110 is not likely to be ported to a non-vendor switch and, thereby, be subject to a non-vendor hacker. The database files are typically proprietary as between Telcos, particularly in the case of EWSD technology, and can not run even on another EWSD switch of another Telco.

The operation of the invention shall now be described. To open (i.e., unlock) the security lock, the authorized personnel from the Telco must generate and store the security key, for example an 8-digit alphanumeric character string. In one embodiment, the key would be stored in encrypted form inside the switch database. In this embodiment, the invention allows the security key to be regenerated in the encrypted form in order to allow the database to be copied and the upgrade carried out. The authorized personnel of the Telco also have the ability to close (i.e., lock) the box using the security key.

The database is transferred to the vendor, who performs the app (APS) upgrade. After the APS upgrade is completed, the security lock continues to be maintained in the locked state. The security key is transferred in encrypted form from the old APS to the new APS in an encrypted form. In the locked state, the display commands are blocked and, therefore, the vendor is prevented from viewing the intercept data through the database commands. Since the encrypted data portion 110 does not affect function of the lawful surveillance programming (such e.g. CALEA) and any associated upgrades, the Telco personnel are not required to provide the access key for the upgrade. Then the upgraded database file containing the secure, locked data is transferred back to the Telco for reinstallation on its switch 100.

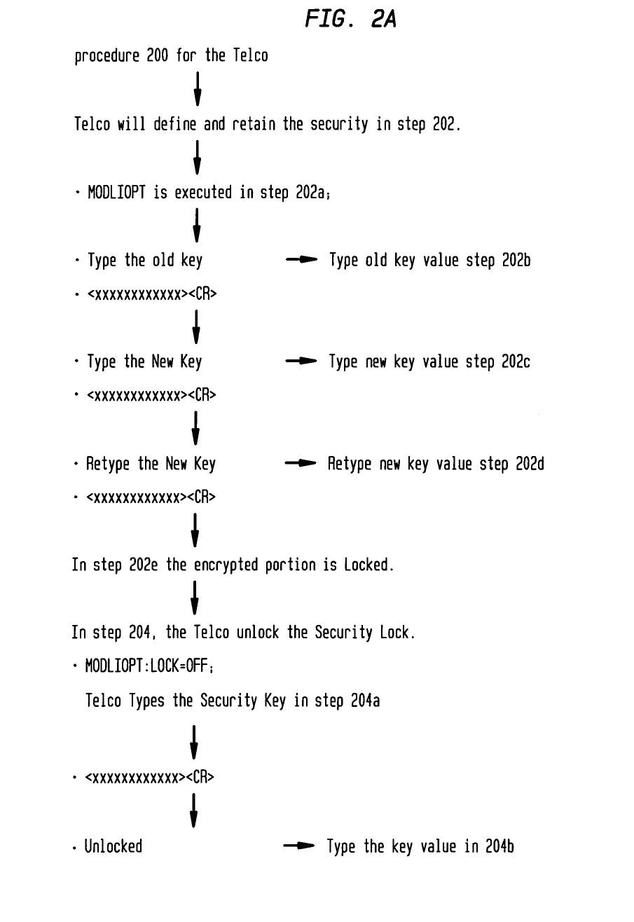

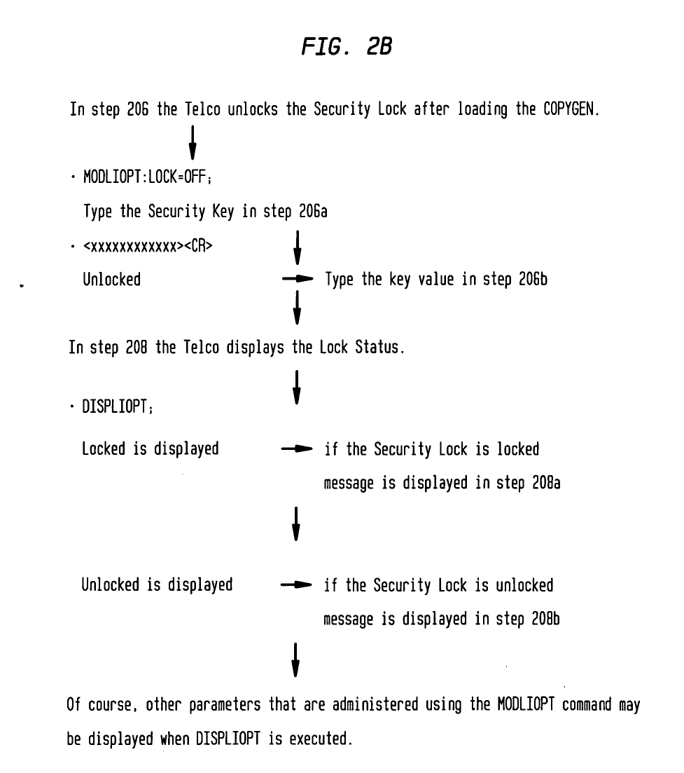

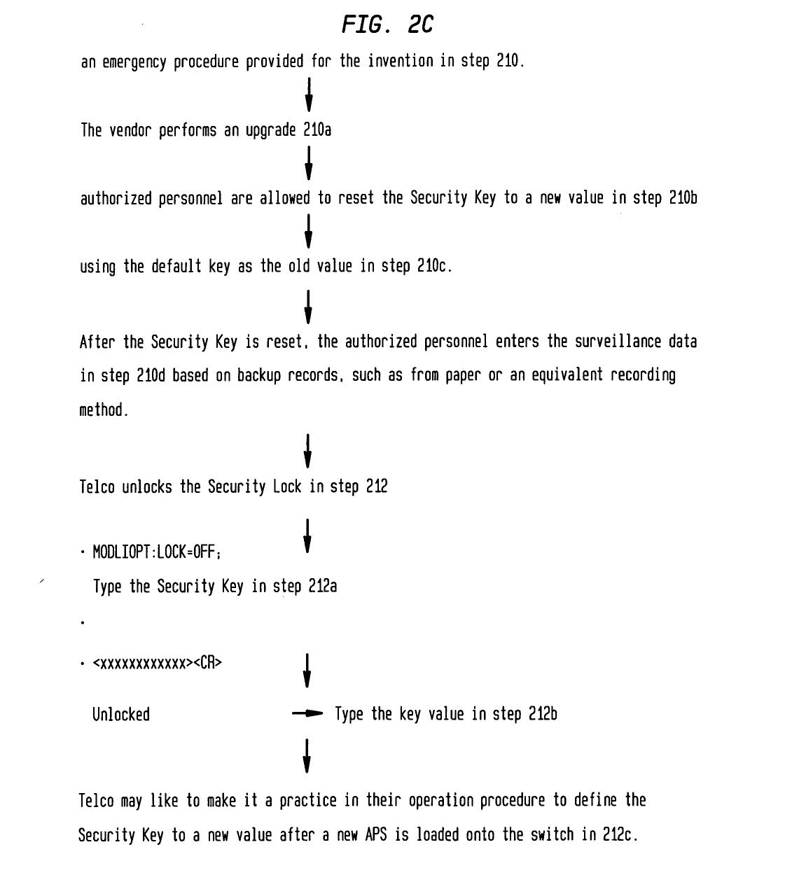

Now with respect to FIGS. 2A-F, the key generation and use procedures 200 for the Telco shall be set forth according to one embodiment of the invention. After receiving the upgraded database 110, the Telco will defines and retains the security key as provided in steps 202[x]. It should be noted that the commands used in the processes below are exemplary only and are specific to the EWSD telecommunications switch. Details regarding these specific commands may be found within the Siemens EWSD Functional Specifications which are incorporated by reference herein in their entirety.

Before explaining the key generation process, however, the details of a default key should be provided. In one particular aspect of the present invention, a default key is provided when the database is initially delivered to the Telco so that the security key may be generated for the first time. The presence of a default key does not compromise the database security, however, since the only use for the default key is to reset the Security Key value. As a prerequisite to reset the Security Key, the EWSD switch data must be erased, e.g. the database would not have any secure surveillance data. Since the MML command used to lock/unlock and to reset the Security Key can only be executed by the authorized specific personnel of the operating company, an unauthorized person cannot use the MML command to determine whether the EWSD switch has any surveillance capability or associated data.

Referring again to FIG. 2A, immediately after receiving an EWSD switch with upgraded APS, the Telco defines the Security Key using the default key as the old key value. In terms of EWSD MML command language, the command MODLIOPT is used to define the Security Key as follows.

| | |
|---|---|
| MODLIOPT is executed in step | |
| 202a; | |
| Type the Old Key | → Type old key value step 202b |
| <xxxxxxxxxxxx><CR> | |
| Type the New Key | → Type new key value step 202c |
| <xxxxxxxxxxxx><CR> | |
| Retype the New Key | → Retype new key value step 202d |
| <xxxxxxxxxxxx><CR> | |

At step 202e the encrypted database portion is locked, but the new Security Key is defined, and the Security Lock is in a locked status.

In step 204, the Telco unlocks the Security Lock. Normally, the Security Lock is in a open (i.e., unlocked) condition during the normal switch operation to allow the authorized personnel to perform their normal CALEA related OA&MP functions. The following MML command is used to unlock the Security Lock.

| | |
|---|---|
| MODLIOPT: LOCK = OFF; | |
| Telco Types the Security Key in step 204a | |
| <xxxxxxxxxxxx><CR> | |
| Unlocked | → Type the key value in 204b |

Referring to FIG. 2B, in step 206 the Telco unlocks the Security Lock after loading the COPYGEN. After loading the COPYGEN into a switch, open (i.e., unlock) the Security Lock. The following MML command is used to unlock the Security Lock.

| | |
|---|---|
| MODLIOPT: LOCK = OFF; | |
| Type the Security Key in step 206a | |
| <xxxxxxxxxxxx><CR> | |
| Unlocked | → Type the key value in step 206b |

In step 208 the Telco displays the Lock Status. The authorized personnel of the Telco can use the following MML command to display the status of the Security Lock.

| | |
|---|---|
| DISPLIOPT; | |
| Locked is displayed | → if the Security Lock is locked |
| | message is displayed in step 208a |
| Unlocked is displayed | → if the Security Lock is unlocked |
| | message is displayed in step 208b |

Of course, other parameters that are administered using the MODLIOPT command may be displayed when DISPLIOPT is executed.

Referring to FIG. 2C, an emergency procedure provided for the invention in step 210 in the event the Security Key is lost. The vendor performs an upgrade 210a, for example, with no surveillance data present. When surveillance data does not exist, the authorized personnel are allowed to reset the Security Key to a new value in step 210a using the default key as the old value in step 210b. After the Security Key is reset, the authorized Telco personnel may enter the surveillance data in step 210c based on backup records, such as from paper or an equivalent recording method. No mechanism for directly recovering a lost key is envisioned since this would represent a “back door” around the security provided by this invention.

After getting the upgraded APS, the Telco unlocks the Security Lock in step 212 using the Security Key to allow the authorized personnel to display the surveillance specific data. The following MML command is used to unlock the Security Lock.

| | |
|---|---|
| MODLIOPT: LOCK = OFF; | |
| Type the Security Key in step 212a | |
| <xxxxxxxxxxxx><CR> | |
| Unlocked | → Type the key value in step 212b |

As an option, the Telco may like to make it a practice in their operation procedure to define the Security Key to a new value after a new APS is loaded onto the switch in step 212c.

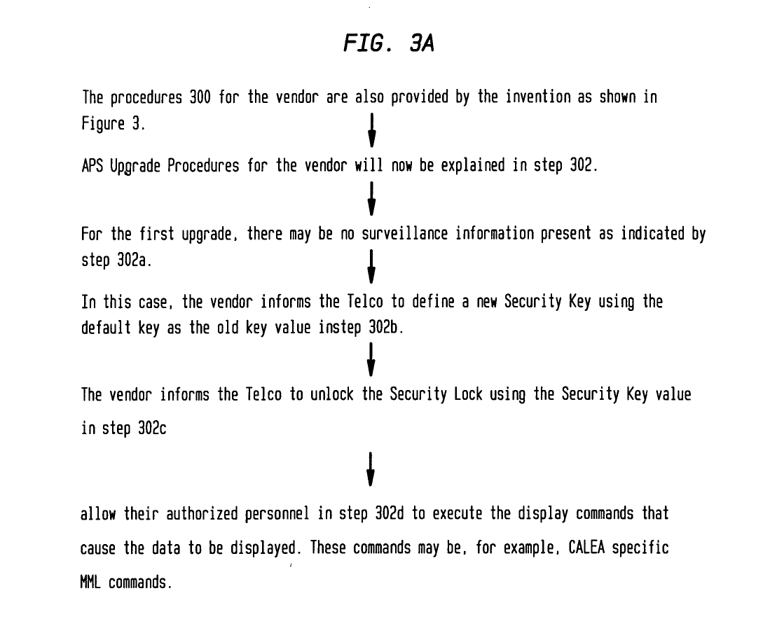

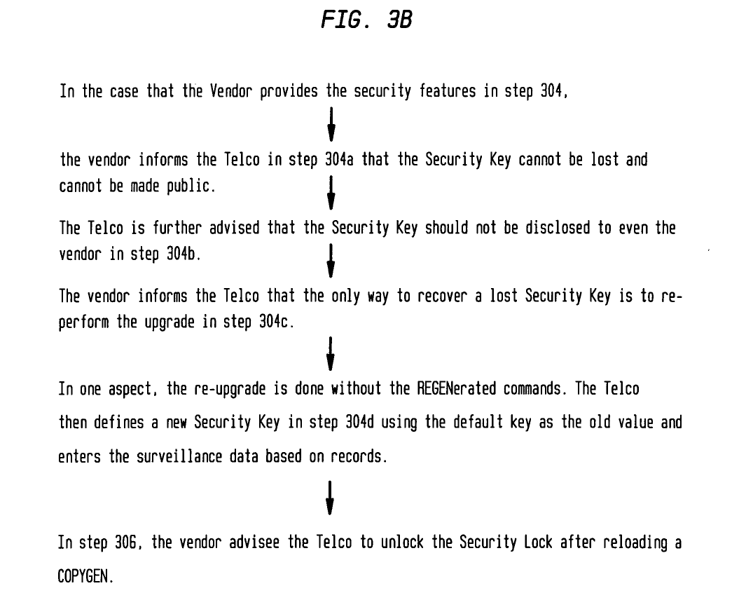

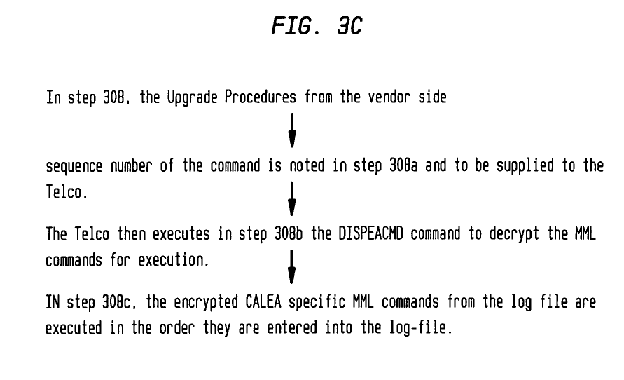

Referring to FIGS. 3A-3C, the APS upgrade procedures 300 for the vendor are also provided by the invention.

With respect to FIG. 3A, APS Upgrade Procedures for the vendor will now be explained in step 302. For the first upgrade, there may be no surveillance information present as indicated by step 302a. In this case, the vendor informs the Telco to define a new Security Key using the default key as the old key value instep 302b. The vendor informs the Telco to unlock the Security Lock using the Security Key value in step 302c in order to allow their authorized personnel in step 302d to execute the display commands that cause the data to be displayed. These commands may be, for example, CALEA specific MML commands.

In the case that the Vendor provides the security features in step 304, the vendor informs the Telco in step 304a that the Security Key cannot be lost and cannot be made public. The Telco is further advised that the Security Key should not be disclosed to even the vendor in step 304b. The vendor informs the Telco that the only way to recover a lost Security Key is to re-perform the upgrade in step 304c. In one aspect, the re-upgrade is done without the REGENerated commands. The Telco then defines a new Security Key in step 304d using the default key as the old value and enters the surveillance data based on records.

In step 306, the vendor advises the Telco to unlock the Security Lock after reloading a COPYGEN. Further the vendor advises the Telco to unlock the Security Lock if the EWSD switch hits a ISTART2 recovery.

In step 308, the Upgrade Procedures from the vendor side will now be discussed. If an encrypted, REGENarated, MML command is rejected, the sequence number of the command is noted in step 308a and to be supplied to the Telco. The Telco then executes in step 308b the DISPEACMD command to decrypt the MML commands for execution. In step 308c, the encrypted CALEA specific MML commands from the log file are executed in the order they are entered into the log-file.

With the present invention, there is provided multiple levels of protection as well as mechanisms to allow normal maintenance operations to take place without compromising the data. This is in addition to the normal access control mechanisms that allow authorized Telco 102 users to access the sensitive data via MML commands specific to the sensitive data.

The first level of protection is in encryption of certain files. This includes the log of MML commands related to the sensitive data as well as the database regeneration of that sensitive data. The second level of protection is to provide a lock that locks out display of the sensitive data even if a person has the authorization to execute the display commands. The third level of protection is to store the key associated with the “display lockout” in the encrypted file. This last part is important because it prevents a person from loading the data on a new switch and gaining access to the data by unlocking the display lockout on that new switch. If the display lockout “key” on the new switch does not match the display lockout “key” stored in the database files from the Telco's switch, all access to the sensitive data is blocked.

It shall be appreciated that, although the present invention has been described with respect to a specific embodiment, the invention is not so limited and covers the broad aspect of providing secure lawful intercept data and that other variations and modifications are within the scope of the invention.

1. A method for securing lawful intercept related data collected by a switch of a telecommunications service provider and stored in a database associated with the switch, comprising the steps of:
encrypting that portion of the database including the intercept related data; and
preventing another entity outside the telecommunications service provider from decrypting that portion of the database including the intercept related data without authorization from the telecommunications service provider.

2. The method according to claim 1, further comprising the step of creating a logical key at the telecommunications company that allows that portion of the database including the intercept related data to be decrypted.

3. The method according to claim 1, further comprising the step of inserting the logical key into that portion of the database including the intercept related data to be encrypted.

4. The method according to claim 1, further comprising the step of creating the key creates a software key that is used for the encryption of that portion of the database including the intercept related data.

5. The method according to claim 1, further comprising the step of blocking access to display commands that cause that portion of the database including the intercept related data to be displayed by the switch.

6. The method according to claim 1, further comprising the step of sending the data base to a vendor with that portion of the database that is encrypted.

7. The method according to claim 6, further comprising the step of upgrading by the vendor without the need to decrypt or otherwise provide access to the sensitive intercept related data.

8. The method according to claim 1, further comprising the step of storing programming code for controlling the switch in that portion of the database including the intercept related data.

9. The method according to claim 1, further comprising the step of providing protection for the intercept related data in accordance with a lawful intercept legislation.

10. The method according to claim 9, wherein the lawful intercept legislation is CALEA.

11. An apparatus for securing intercepted telecommunications data collected by a telecommunications service provider, comprising:
a database for storing the intercept related data; and
a logical key at the telecommunications company that allows that portion of the database including the intercept related data to be decrypted.

12. The apparatus according to claim 11, further comprising a switch at the telecommunications service provider.

13. The apparatus according to claim 11, wherein the logical key is a software key that used for the encryption of that portion of the database including the intercept related data.

14. The apparatus according to claim 11, further comprising a vendor switch.

15. The apparatus according to claim 14, wherein the vendor switch is programmed to prevent display of commands that cause that portion of the database including the intercept related data to be displayed.

16. The apparatus according to claim 11, wherein the database includes upgradeable control data for controlling the switch.
